(19) United States
(12) Patent Application Publication
(10) Pub. No.: US 2025/0319602 A1
(43) Pub. Date: Oct. 16, 2025

(54) Method of calibration of NDT systems for measurement of the internal structure of large-scale objects

(71) Applicant: Radalytica a.s., Olomouc (CZ)

(72) Inventor: Josef UHER, Rožnov pod Radhoštem (CZ)

(21) Appl. No.: 19/040,877

(22) Filed: Jan. 30, 2025

Related U.S. Application Data
(60) Provisional application No. 63/633,790, filed on Apr. 14, 2024.

(51) Int. Cl. B25J 9/16; B25J 19/02

(52) U.S. Cl. CPC B25J 9/1692; B25J 9/1653; B25J 9/1661; B25J 19/021

(57) ABSTRACT

The calibration method for non-destructive measurement of the internal structure of large-scale objects (4), comprising robotic arm (1) equipped with a source (2) of penetrating ionizing radiation, robotic arm (7) equipped with an imaging detector (6) of ionizing radiation, and a server for synchronized control of the robotic arms connected for communication to the robotic arms (1, 7). Any robotic arm (1, 7) changes its position at least once by a defined delta change. The change in the position of incidence of the beam (5) on the imaging detector (6) is measured, or the change in the position of the robotic arm (7) with the imaging detector (6) is measured to maintain the initial position of incidence of the collimated beam (5). The defined delta change and the associated changes are used to calculate the relative position of the source (2) in relation to the imaging detector (6).

### FIELD OF THE INVENTION

The invention relates to the proper alignment and synchronization of robotic arms for non-destructive testing systems for measurement of the internal structure of large-scale objects using penetrating radiation.

### BACKGROUND OF THE INVENTION

Currently, the 3D internal structure of non-transparent (opaque) objects is examined in a non-destructive manner using computed tomography. This is a method in which a set of 2D images of the internal structure of the object under examination is taken through exposure to penetrating ionizing radiation from different viewing directions of the object under examination, whereupon a 3D model of the internal structure of the object under examination is computationally developed from the images. In order for this method to work, it is necessary to know the exact position of the source of penetrating ionizing radiation directed at the object under examination and the exact position of the imaging detector of the ionizing radiation emitted from the object under examination when each 2D image is taken.

In systems for testing limited-size objects, the relative position of the source of penetrating ionizing radiation and the imaging detector of ionizing radiation can be calculated from a set of 2D images of a reference object, i.e. an object of known size and shape. This is time-consuming and computationally intensive method commonly used in practice, in particular for robotic CT scanners, which use robots with good position repeatability but are not sufficient accuracy. It is then possible to scan any object that can be placed into the device.

The problem of determining the relative position of the source of penetrating ionizing radiation and the imaging detector of ionizing radiation arises when it is necessary to use NDT technique for testing large-scale objects, e.g. tanks and silos, aircraft fuselages, etc., which cannot be replaced by a reference object.

Known equipment and systems used for non-destructive testing generally include a source of penetrating ionizing radiation. Penetrating ionizing radiation can be understood as X-rays, gamma rays, neutrons, etc., therefore the source of penetrating ionizing radiation is, for example, an X-ray tube, a radioactive element/isotope, etc. An ionizing radiation detector is an imaging detector that not only detects the incidence of penetrating ionizing radiation, but can assign it to a specific pixel of its area sensor, hence an imaging detector. It is becoming a common practice for the source of penetrating ionizing radiation and the imaging detector of ionizing radiation to be carried on robotic arms that can be programmed to move in a very precise and synchronized manner. Robotic arms are characterized by precision of movement, number of degrees of freedom of movement, etc. Robotic arms are usually controlled by a common server that controls their movement in space to synchronize them. The arms can be placed on portable bases that allow the device to be moved to the object to be measured. In this case, a precise determination of the relative position of the robots is needed before measurement.

The purpose of the invention is to provide a method of calibration of NDT systems for measurement of the internal structure of large-scale objects, which would allow the exact position of the source of penetrating ionizing radiation and the imaging detector of ionizing radiation to be determined prior to making measurements when they are mutually obscured by a large-scale object.

### SUMMARY OF THE INVENTION

The object of the invention is achieved by providing a method of calibration of NDT device for measurement of the internal structure of large-scale objects according to the invention described below.

The calibration method relates to devices for non-destructive measurement of the internal structure of large-scale objects, comprising at least one robotic arm equipped with a source of penetrating ionizing radiation, at least one robotic arm equipped with an imaging detector of ionizing radiation, and a server which controls the synchronized movement of the robotic arms carrying the measurement equipment, which is connected for communication to the robotic arms carrying the measurement equipment.

The core of the invention is that the invented method comprises the following procedural steps:
(a) An area of interest to be examined is determined on the measured large-scale object. Because the large-scale object obstructs visibility between the robotic arms, an initial area is established on it, relative to which the robotic arms will subsequently be positioned.
(b) The robotic arms carrying the measurement equipment shall be arranged relative to the initial area on the large-scale object to ensure that the collimated beam of penetrating ionizing radiation passes through the initial area of the large-scale object from the source of penetrating ionizing radiation to the imaging detector of ionizing radiation. By positioning the robotic arms in relation to the initial area, it is easier to make the penetrating ionizing radiation pass through the initial area of the large-scale object and fall anywhere on the sensitive area of the imaging detector.
(c) The collimated beam of penetrating ionizing radiation is activated and by changing the position of the robotic arms, the imaging detector is adjusted relatively to the collimated beam of penetrating ionizing radiation to the initial position of incidence of the beam for calibration. The initial position of incidence of the collimated beam is usually the centre of the sensitive area of the imaging detector, but any part of the sensitive area of the imaging detector can be defined as the source region if required.
(d) Any robotic arm changes its position at least once by a defined delta change, wherein the change in the position of incidence of the beam on the imaging detector is measured, or the change in the position of the robotic arm with the imaging detector is measured at the same time to maintain the initial position of incidence of the collimated ionizing radiation beam on the sensitive area of the imaging detector. For data acquisition, either the change in the position of incidence of the collimated beam can be measured, or the change in the position of the arm carrying the imaging detector can be measured, which must perform the change in the position to maintain the initial point of incidence on the sensitive area of the imaging detector. Alternatively, data can be combined from both options.
(e) The defined delta change and the associated changes in the position of incidence of the collimated beam on the imaging detector or the change in the position of the robotic arm carrying the imaging detector are used to calculate the relative position of the source of penetrating ionizing radiation in relation to the imaging detector of ionizing radiation that is used for calibration of the non-destructive testing equipment and the equipment is subsequently calibrated. The known relative positions can be then used to instruct the server controlling the robotic arms to precisely position the source of penetrating ionizing radiation in relation to the imaging detector without the large-scale object obstructing visibility.

The collimated beam has a known shape for the calculations, and is sufficiently penetrating to not be shielded by the material for calibration of the obstructing large-scale object. Well-known imaging detectors have sensitive areas composed of a dense array of pixels, so that it is possible not only to detect the collimated beam but also to track its direction of propagation through space with great precision. With the innovative use of specified changes in the position of the robotic arm by delta change, it is possible to measure the response of the system, either as a change in the point of incidence of the collimated beam, or as a change in the position of the robotic arm carrying the imaging detector to maintain the initial point of incidence of the collimated beam. If this data is known, the position of the source of collimated beam of ionizing radiation in relation to the imaging detector can be accurately determined using goniometric calculations in the coordinate system.

It is preferred if the delta change is rotation, i.e. the direction of the collimated beam is changed by specified angle (FIG. 2). This means that during procedural step (d) the robotic arm carrying the source of penetrating ionizing radiation moves the collimated beam of penetrating radiation by defined number of degrees and the robotic arm carrying the imaging detector tracks the beam by moving the imaging detector in a plane defined by the sensitive area of the imaging detector, while the projection of the collimated beam remains at the centre of the imaging detector and the necessary movement of the arm carrying the imaging detector is recorded at the same time to keep the projection of the beam at its centre. This procedural step can be performed either vertically, horizontally, or in both directions. In this procedure, two triangles are basically copied that should be rectangular in properly calibrated device and should have equal sides. If the calculation shows that the sides of the triangle are not of the same size, the relative position of the robots is not correct and therefore a new one will be calculated, i.e. the device will be calibrated.

Another preferred delta change is to move the imaging detector perpendicular to its sensitive area (FIG. 3). This means that during procedural step (d) the robotic arm carrying the imaging detector moves the imaging detector in the direction perpendicular to the plane of the imaging detector, while the projection of the collimated beam moves along the surface of the imaging detector, whereupon the angle of incidence of the collimated beam on the imaging detector is determined by calculating the size of the trajectory of movement of the imaging detector, and the distance determined from the displacement of the position of the collimated beam on the imaging detector. Basically, this is a simple application of goniometric functions, because the angle between two sides of known size in a right triangle is missing. If the angle of incidence of the collimated beam is known, it is possible to start the calibration by changing the positions of at least one of the robotic arms. This method determines the direction of the beam, not the distance between the source and the detector and its complete orientation in space. It is therefore suitable, for example, for 2D imaging or in combination with other methods to improve the quality and speed of calibration.

The last preferred option for delta change is to move the imaging detector along the collimated beam. This means that during procedural step (d) the robotic arm carrying the imaging detector moves the imaging detector along the collimated beam of penetrating ionizing radiation, measuring the sequence of points of incidence of the collimated beam on the imaging detector, whereupon the points of incidence define the line of collimated beam, and this process is repeated for at least two other lines of collimated beam deflected by defined angle, whereupon the intersection of the found lines of incidence determines the exact position of the source of penetrating ionizing radiation in the coordinate space of the imaging detector. By performing procedural step (d) it is possible to determine the exact position of the source of ionizing radiation, which can be used for subsequent calibration of the device for non-destructive measurement.

It is preferred if the above procedures working with delta change are combined with each other before subsequent calibration.

Preferably, the process of determining the relative arrangement of the source and the imaging detector for calibration purposes can be accelerated and facilitated by mechanically connecting the flanges of the robotic arms for carrying the measurement equipment with a holder of known length and size prior to procedural step (b), while measuring the relative position of the robotic arms and the deflection of the holder in relation to the flanges when the robotic arms move. This procedure provides basic data which, when the robotic arms are later positioned in relation to the source region of the large-scale object, facilitates the initial setting so that the collimated beam hits the imaging detector and the acquisition of the measured values can proceed immediately for calibration purposes.

It is also possible to accelerate and facilitate the process of determining the relative arrangement of the source and the imaging detector for calibration purposes by equipping the robotic arms with a laser for distance measurement prior to procedural step (b), whereupon a reference plate is placed between the robotic arms, the surface of which is equally rough on both opposite sides, and subsequently the distance of each of the robotic arms from the reference plate is measured using laser measurement, and then the relative position of the robotic arms in relation to each other is evaluated by comparing the data for the same surface detail.

Precise calibration of the relative position of the robots by the collimated beam relies on the precise connection of the position of emission and radiation detection in relation to the end points of the robotic arms. It is therefore necessary to determine geometrically the point where radiation is produced, e.g. X-ray tube (emission spot). Similarly, the exact centre of the sensitive area in relation to the robot must be determined for the detector. This calibration can be performed on the basis of projection of the fixed reference point onto the detector in combination with the delta movement of the radiation source (FIG. 8) or the detector (FIG. 9). In the first step, the projection of the reference point, which can be for example a steel ball, is centred on the centre of the detector by robot movements. To detect the error in the knowledge of the emission spot, the source is then rotated by known angle around the set point. If the centre of rotation of the radiation source does not coincide with the emission spot, the projection of the reference point is shifted in the measured image. The displacement and the knowledge of the angle of rotation are used to calculate the correct position of the emission spot in relation to the robot. By rotating around the vertical “X” or “Y” axis, the position of the emission spot in the “Z” direction, i.e. in the source-detector direction, can be determined. By rotating around the “Z” axis, the position of the emission spot in the “X” and “Y” directions can be obtained. The same way is used to determine the centre of the sensor, i.e. by rotating the detector around the “X” or “Y” axis by known angle, the projection of the reference point is shifted, which is used to calculate the correct position in the “Z” direction, and by rotating it around the “Z” axis, the positions in the “X” and “Y” directions are then determined.

The methods described above for the calibration of the relative position of the robots can also be used when the robots are mounted on another positioning device such as rails or other larger robotic arms. In this case, it is necessary to calibrate not only the relative position of the robots in one location, but also the individual positions set by rails or larger robotic arms, between each other. In this case, the procedure shown in FIG. 10 can be used. The first position of both robots is calibrated. Then one of the robots (e.g. with the radiation source) is moved to the next position and their relative position is calibrated again. This will link the first location to the next. In the next step, the radiation detector is moved and the relative position of the two robots is calibrated again, this time for the actual measurement at this point. This can be done until the full range of motion of the next positioning device is geometrically calibrated. The overall positional calibration of the device is obtained, where the individual measurement points are geometrically connected and therefore the resulting scan data can be easily combined in 3D space.

One of the advantages of the invention is that it can enable calibration of equipment for non-destructive measurement of the structure of large-scale objects after placing its robotic arms in front of and behind the large-scale object to be measured, which obstructs direct visibility. By using the defined delta change procedure, it is possible to locate the source and imaging detector in space, so that control of the robotic arms and adjustment of their position is then the result of calculations in the coordinate system.

### BRIEF DESCRIPTION OF DRAWINGS

The present invention will be explained in detail by means of the following figures where:

FIG. 1 shows a diagram of the device for non-destructive measurement of the internal structure of large-scale objects,

FIG. 2 shows a diagram of measurement with delta change aimed at deflecting the directional angle of the collimated beam,

FIG. 3 shows a diagram of measurement with delta change aimed at moving the imaging detector in the direction perpendicular to its sensitive area,

FIG. 4 shows a diagram of measurement with delta change aimed at moving the imaging detector in the direction of the collimated beam to determine its point line,

FIG. 5 shows a graphical representation of the actual measurement according to the variant of the invention depicted in FIG. 4,

FIG. 6 shows a diagram of the device for non-destructive measurement of the internal structure of large-scale objects, where the reference plate with equal opposite sides is used instead of large-scale object,

FIG. 7 shows a diagram of the device for non-destructive measurement of the internal structure of large-scale objects, where the robotic arms are connected by a mechanical coupling for calibration purposes,

FIG. 8 shows the calibration procedure of the position of the emission spot of the source of radiation,

FIG. 9 shows the calibration procedure of the position of the centre of the sensor of the imaging detector,

FIG. 10 shows a diagram of the gradual calibration of the positions of another positioning device that changes the position of the robot bases.

### EXAMPLE OF THE INVENTION EMBODIMENTS

In the examples of the invention embodiments, specific values for the distances of the robotic arms are not given, as this is basically an application of geometry in space. The values for space are always defined by specifying a reference point to which everything relates (point 0,0,0) and which defines the parameters of the “scene”. The detailed description of the “scene” is more important than the numerical values. Scale is not important either, because it is the geometry that will always be the same, whether for micro or metre displacements. Therefore, the most important information for an expert are the images with the scene presentation, according to which the expert can then apply specific solution for his/her own “scenes”.

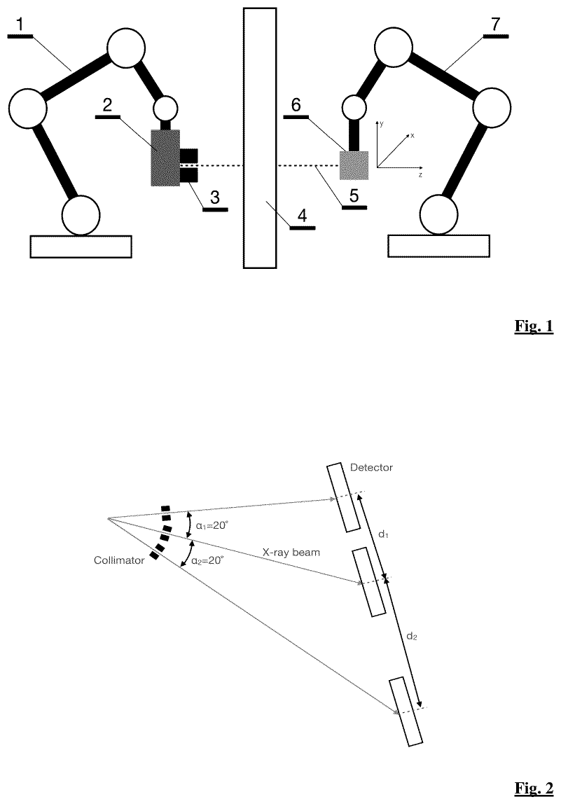

FIG. 1 shows a diagram of the device for non-destructive measurement of the internal structure of large-scale objects. The device includes universal robotic arms 1, 7, known as UR-5. Furthermore, a source 2 of penetrating ionizing radiation, which can be, for example, an X-ray tube “Oxford Instruments Apogee 5500 with 50 kVp @ 1 mA”. The source 2 of penetrating ionizing radiation is equipped with a collimator 3, e.g. lead collimator with a hole 0.5 mm in diameter. Using the collimator 3, a precise X-ray beam 5 is obtained. FIG. 1 shows that the large-scale object 4 is located between the arms 1, 7. The imaging detector 6 is e.g. a Widepix 2×5 MPX3 X-ray imaging detector with a 1 mm thick CdTe sensor. An expert is able to use other specific solutions of individual components of the device, the above list of specific components is not limiting, only illustrative.

FIG. 2 shows a diagram of the use of delta changes in determining the relative position of the source 2 in relation to the imaging detector 6, in which the delta changes are aimed at deflecting (changing the directional angle α1, α2) of the collimated beam 5. Any change in the angle α results in the need to change the position of the imaging detector 6 so that the collimated beam 5 is still incident on the initial position of incidence (centre) of the imaging detector 6. The change in the position of the imaging detector 6 is reflected by the trajectory d1, d2, etc., i.e. the movement of the robotic arm 7.

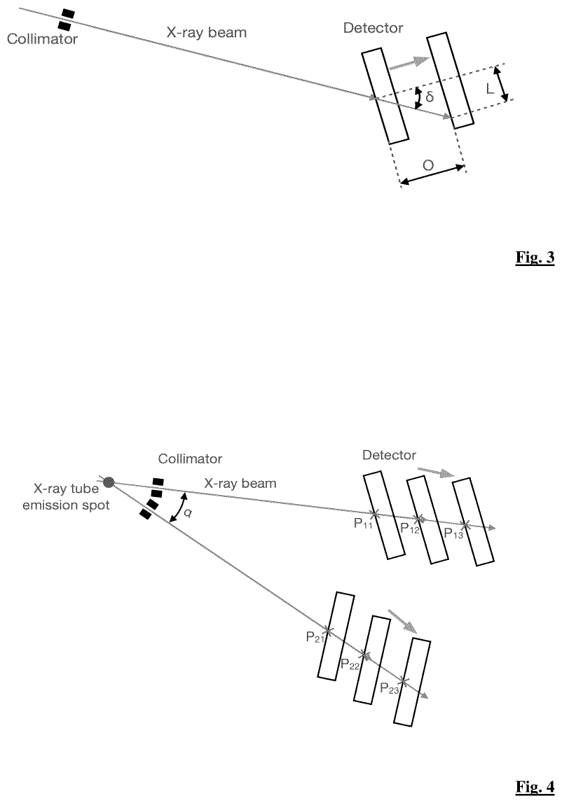

FIG. 3 shows a diagram of the use of delta changes in determining the relative position of the source 2 in relation to the imaging detector 6, in which the delta changes are aimed at moving the imaging detector 6 in the direction perpendicular to its sensitive area. The collimated beam 5 falls on the imaging detector 6 in its initial position of incidence (centre), whereupon it moves with the imaging detector 6 by trajectory O, the point of incidence of the beam 5 being displaced by path L. The two values can be used to determine the angle δ of incidence of the collimated beam 5 by calculation, and this information can be used for subsequent calibration of the source 2 in relation to the imaging detector 6.

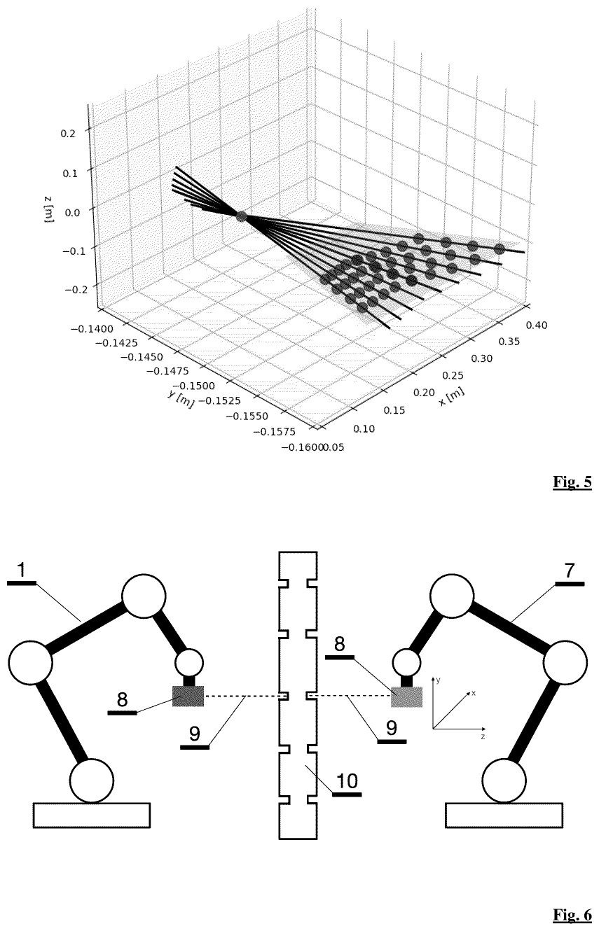

FIG. 4 shows a diagram of the use of delta changes in determining the relative position of the source 2 in relation to the imaging detector 6, in which the delta changes are aimed at moving the imaging detector 6 in the direction of the collimated beam 5. At least two lines of incidence are created for the beam 5 with different angle α of orientation into space, and several points (P11, P12, P13, P21, P22, P23) of incidence are recorded in each line of incidence to the initial position of incidence of the beam 5 (centre) of the imaging detector 6. The imaging detector 6 moves along the beam 5. Knowledge of the at least two lines of incidence enables the determination of the position of the source 1 in relation to the imaging detector 6. FIG. 5 shows a graphical representation of the actual test measurement results.

FIG. 6 shows a diagram of the preliminary adjustment of the relative position of the robotic arms 1, 7, in which a reference plate 10, the surface of which is equally rough on both sides, is placed between the robotic arms 1, 7. The robotic arms 1, 7 are equipped with lasers 8, the beams 9 of which are used to measure the distance of the robotic arms 1, 7 from the reference plate 10. This not only determines the absolute positional accuracy and behaviour of the robotic arms 1, 7, but also determines their relative positions.

In FIG. 7, the adjustment of the relative position of the robotic arms 1, 7 is realized by hanging a holder 11 of known length and size between the robotic arms 1, 7 by mechanical connection. As the robotic arms 1, 7 are moved, data from the robotic arms 1, 7 is recorded, as well as data about the tilt and direction of the holder, which can be used to calculate the relative position of the robotic arms 1, 7. This data can be used in calibration using delta changes.

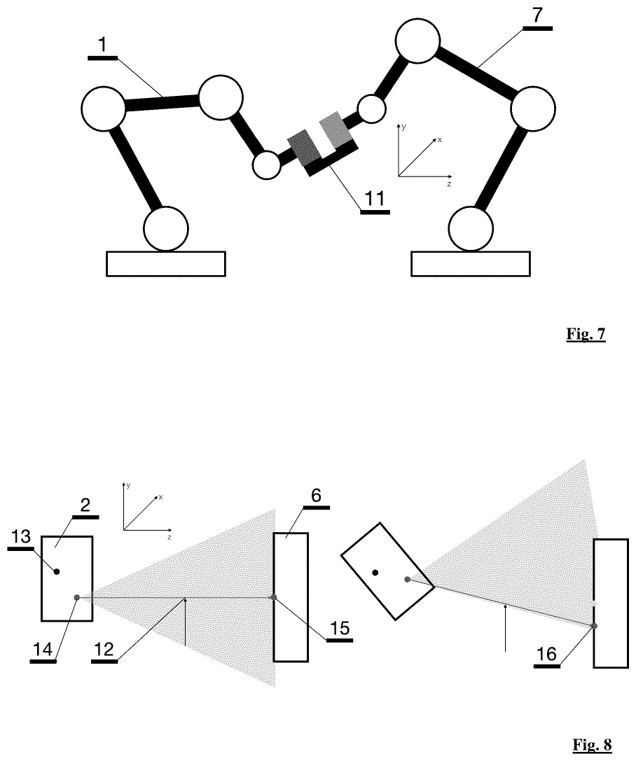

FIG. 8 shows the calibration of the emission spot of the radiation source 14. By rotating the source 2 around the incorrectly determined point 13, the projection of the reference object 12 (ball) onto the detector 6 is shifted from position 15 to position 16. The angle and direction of rotation of the source and the distance of shift of the projection can be used to calculate the correct position of the emission spot 14 of the source 2.

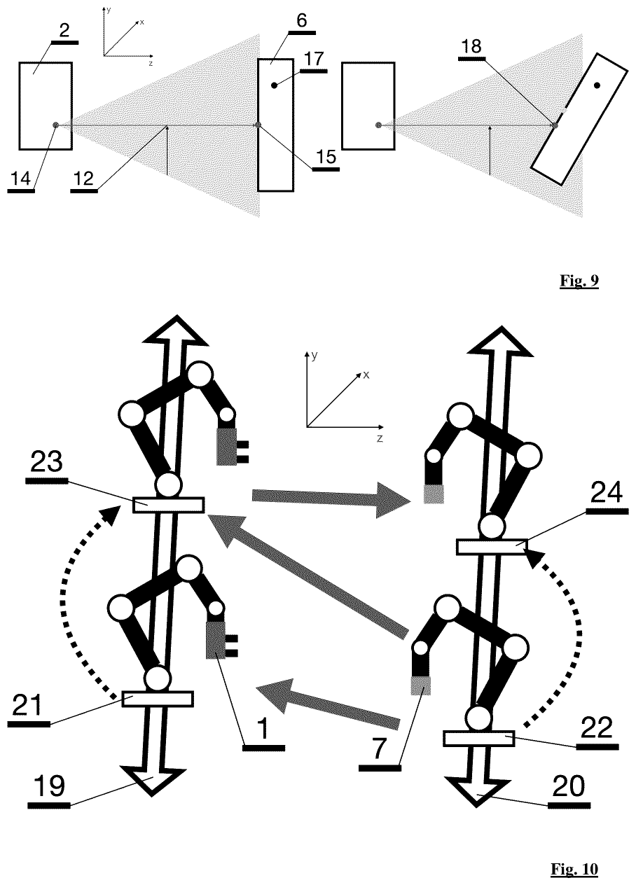

FIG. 9 shows the calibration of the centre 17 of the imaging detector 6. By rotating the detector 6 around the incorrectly determined point 15, the projection of the reference object 12 (ball) is shifted from position 15 to position 18. The angle and direction of rotation of the detector 6 and the distance of shift of the projection can be used to calculate the correct position of the centre of the detector 17.

FIG. 10 shows the gradual calibration of the measuring points of the robotic arms 1 and 7, which are located on another positioning device 19 and 20, e.g. larger robotic arms or rails. The robotic arms 1 and 7 are first placed in the first positions 21 and 22. The calibration of their relative positioning is performed in those positions. In the next step, the robotic arm 1 with the radiation source is moved to the second position 23 and the calibration of the position in relation to the robotic arm 7 is performed again. This provides information about the relative position of the measuring point in the first positions 21 and 22 and the measuring point in the second positions 23 and 24. Next, the robotic arm 7 is moved to the second position 24. The relative position between the robotic arms 1 and 7 in the second positions 23 and 24 will be calibrated. This method can be used for linear positioning devices as well as for positioning using additional robotic arms in 3D space.

### INDUSTRIAL APPLICABILITY

The method of calibration of NDT equipment for measurement of the internal structure of large-scale objects finds its application in industry.

### LIST OF REFERENCE NUMERALS

1 robotic arm carrying the source of penetrating ionizing radiation
2 source of penetrating ionizing radiation
3 collimator of penetrating ionizing radiation
4 large-scale object
5 collimated beam of ionizing radiation
6 imaging detector
7 robotic arm carrying the imaging detector
8 laser for distance measurement
9 laser beam
10 reference plate
11 coupling between robots
12 reference object
13 specified point for the source
14 emission spot
15 projection position of the specified point
16 projection position of the emission spot
17 centre of the imaging detector
18 projection position of the centre of the detector
19 first positioning device
20 second positioning device
21 first position of the robotic arm with the radiation source
22 first position of the robotic arm with the detector
23 second position of the robotic arm with the radiation source
24 second position of the robotic arm with the detector

1. A method of calibration of a device for non-destructive measurement of the internal structure of large-scale objects, comprising at least one robotic arm equipped with a source of penetrating ionizing radiation, at least one robotic arm equipped with an imaging detector of ionizing radiation, and a server for synchronized control of the robotic arms carrying the measurement equipment, which is connected for communication to the robotic arms carrying the measurement equipment, wherein it comprises the following procedural steps: (a) an initial area shall be established on the large-scale object to be measured; (b) the robotic arms carrying the measurement equipment shall be arranged in relation to the initial area of the large-scale object to ensure that the collimated beam of penetrating ionizing radiation passes through the initial area of the large-scale object from the source of penetrating ionizing radiation to the imaging detector of ionizing radiation; (c) the collimated beam of penetrating ionizing radiation is activated and by changing the position of the robotic arms, the imaging detector is adjusted in relation to the collimated beam of penetrating ionizing radiation to the initial position of incidence of the beam for calibration; (d) any robotic arm changes its position at least once by a defined delta change, wherein the change in the position of incidence of the beam on the imaging detector is measured, or the change in the position of the robotic arm with the imaging detector is measured to maintain the initial position of incidence of the collimated beam of ionizing radiation; (e) defined delta change and the associated change in the position of incidence of the collimated beam on the imaging detector or the change in the position of the robotic arm carrying the imaging detector are used to calculate the relative position of the source of penetrating ionizing radiation in relation to the imaging detector of ionizing radiation that is used for calibration of the relative position of the robotic arms in the NDT device and the device is then geometrically calibrated.

2. The method of claim 1, wherein during procedural step (d) the robotic arm carrying the source of penetrating ionizing radiation rotates the collimated beam of penetrating radiation by defined number of degrees and the robotic arm carrying the imaging detector follows the beam by moving the imaging detector in a plane defined by the sensitive area of the imaging detector, while the projection of the collimated beam remains in the field of vision of the imaging detector and the necessary movement of the robotic arm carrying the imaging detector is recorded at the same time to keep the projection of the beam in its field of vision, with this procedural step being performed either vertically, horizontally, or in both directions.

3. The method of claim 1, wherein during procedural step (d) the robotic arm carrying the imaging detector moves the imaging detector in the direction perpendicular to the plane of the imaging detector, while the projection of the collimated beam moves along the surface of the imaging detector, whereupon the angle of incidence of the collimated beam is determined by calculating the size of the trajectory of movement of the imaging detector, and the distance determined from the displacement of the position of the collimated beam on the imaging detector.

4. The method of claim 1, wherein during procedural step (d), the robotic arm carrying the imaging detector moves the imaging detector along the collimated beam of penetrating ionizing radiation, measuring the sequence of points of incidence of the collimated beam on the imaging detector, whereupon the points of incidence define the line of collimated beam, and this process is repeated for at least two lines of collimated beam deflected from each other by defined angle, whereupon the intersection of the found lines of incidence determines the exact position of the source of penetrating ionizing radiation in the coordinate space of the imaging detector.

5. (canceled)

6. The method of claim 1, wherein, in order to accelerate and facilitate the calibration process, the flanges of the robotic arms for carrying the measurement equipment with a holder of known length and size are mechanically connected prior to procedural step (b), while measuring the relative position of the robotic arms and the deflection of the holder in relation to the flanges when the robotic arms move.

7. The method of claim 1, wherein, in order to accelerate and facilitate the calibration process, the robotic arms are equipped with a laser for distance measurement prior to procedural step (b), whereupon a reference plate is placed between the robotic arms, the surface of which is equally rough on both sides, and subsequently the distance of each of the robotic arms from the reference plate is measured using laser measurement, and then the relative position of the robotic arms in relation to each other is evaluated by comparing the data for the same surface detail of the reference plate.

8. The method of claim 1, wherein, in order to accelerate and facilitate the calibration process, the position of the emission spot of the radiation source is calibrated in relation to the respective robotic arm by projecting the reference object without rotating the radiation source and with rotating the radiation source by known angle prior to procedural step (b), whereupon the correct position of the emission spot is calculated from the displacement in position of the projection of the reference object after rotation of the radiation source to the position.

9. The method of claim 1, wherein, in order to accelerate and facilitate the calibration process, the position of the centre of the sensor of the detector is calibrated in relation to the respective robotic arm by projecting the reference object without rotating the detector and with rotating the detector by known angle prior to procedural step (b), whereupon the correct position of the centre of the detector is calculated from the displacement of the projection of the reference object after rotation of the detector to the point.

10. The method of claim 1, wherein the robotic arms are first provided with positioning devices, then the overall geometric calibration of the robotic arms positioned by the devices is performed in successive steps, where the positions of the robotic arms are calibrated in relation to each other in pairs of positions by method of claim 1, whereupon the positions are calibrated in relation to each other such that one of the robotic arms remains in the given position and the other of the robotic arms is moved to a new position.
